(19) United States
(12) Patent Application Publication
(10) Pub. No.: US 2020/0180138 A1
(43) Pub. Date: Jun. 11, 2020

(54) Flexible Utility Mat

(71) Applicant: Vincent J. D'Alessandro, Long Beach, CA (US)

(72) Inventor: Vincent J. D'Alessandro, Long Beach, CA (US)

(21) Appl. No.: 16/214,033

(22) Filed: Dec. 7, 2018

(51) Int. Cl. B25H 3/00

(52) U.S. Cl. CPC B25H 3/00

(57) ABSTRACT

A flexible magnetic utility mat. The utility mat includes generally circular disks containing magnetic disks within to secure tools, arts and instruments. An elongated magnet portion is designed to secure tool tips. The magnetic disks secure the mat to the work surface.

### CLAIM FOR THE BENEFIT OF PREVIOUS APPLICATIONS

Applicant claims the benefit of Provisional Patent Application Ser. No. US62/596,103, filed Dec. 7, 2017.

### FIELD OF THE INVENTION

The present invention relates to utility tool holders, and more particularly to a flexible magnetic utility holder providing means fop holding the positioning of tools on a surface near an individual.

### BACKGROUND OF THE INVENTION

Tool holders are used as a way to position tools of all kinds near a worker. In all cases, these holders must be able to secure tools, parts and utilities near a worker to make it easier for the worker to gather these tools.

The following prior art discloses the various aspects in the design and Use of tool holders and mats.

U.S. Pat. No. 3,924,212A, granted Aug. 21, 1974, to F. Brown, discloses a A Mechanics protective fender cloth which comprises a pliant cloth-like member and elongated flexible magnetic strips affixed at predetermined intervals along said cloth-like member, a portion of said strips being on one side of said cloth-like member and a further portion of said strips being on the other side of said cloth-like member.

The device, as disclosed by Brown, protects the fender of a car with a porus cloth that possess strips for adherence. The user has virtually no flexibility of such tool positioning away from the magnetic strips, which themselves have no benefit for the user if the tool is between the strips and are unable to hold small pieces such as drill bits or parts.

U.S. Pat. No. 6,587,022 B1, granted Jul. 1, 2003, to R. Devine, discloses a foldable, portable, magnetic tool mat. The tool mat includes generally rectangular obverse and reverse panels each formed of flexible material and connected together along substantially common side and end margins and along evenly spaced apart seam lines extending between said side margins defining elongated magnet bar holding portions.

It is the primary object of the present invention to provide security for holding of tools, and utility parts. At the outset, the mat may hold in place each tool for each individual according to their specific likes and specific task. The subject invention provides flexibility for numerous tasks, such as placement on an automobile fender, ladder or utility truck baskets, known as cherry pickers. As such, this invention is useful not only for automobile repair, but more importantly, this invention can be used in numerous fields, utility line work and even medical equipment.

It is the secondary object of the present invention to provide protection to the surface being worked on. Protection is accomplished by inserting the magnets inside the flexible mat

It is a final object of the present invention to provide another object of the present invention to provide increased worker efficiency, wherein said efficiency is accomplished by having the necessary tools secured nearby.

### BRIEF DESCRIPTION OF THE DRAWINGS

A complete understanding of the invention may be obtained by reference to the accompanying drawings when taken in conjunction with the detailed description thereof and in which:

FIG. 1 is a pictorial representation of the top of the mat. The raised magnetic portion of the mat are spaced evenly throughout the mat to allow a wide variety of positions with which tools may be adhered.

FIG. 2 is a pictorial side view of a magnetic insert inside the mat.

FIG. 3 is a perspective view of the mat to better display the raised magnetic inserts.

A better understanding and appreciation of these and other objects and advantages of the present invention will be obtained upon reading the following detailed description of the preferred embodiment when taken in conjunction with the accompanying drawings.

### SUMMARY OF THE INVENTION

In general, the present invention relates to a device for placing and securing tools, utility parts and other metallic instruments. The device is adapted for precisely securing tools near a worker and work place as well as adding protection to the work place.

More specifically, the invention device separately adheres tools and any metallic utility piece to a workplace, wherein the invention conforms to the work place and protects its surface.

The invention is a flexible mat that possesses numerous magnetic disks physically inserted inside the mat. The magnetic disks provide for the precise attachment of metallic tools, utility pieces and instruments, which are adhered to the work space near the worker.

### DETAILED DESCRIPTION OF THE INVENTION

Tool mats are used as a way to protect a work surface and hold tools. In all cases, the mats usually are ridged, possess magnetic bars or only a few magnetic spaces that either require the individual to choose between a mat that conforms to the surface of the work space or securely holds the tools in place according to each individual's needs.

### DRAWING INDEX

10. Flexible Mat
11. Raised Disks
12. Tip Holders
13. Magnetic Disks

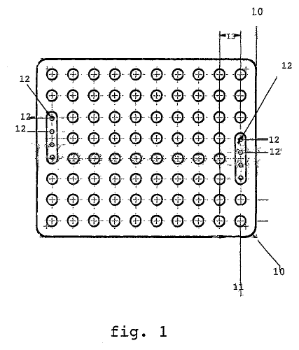

Shown in FIG. 1 is a top view of the Flexible Mat 10 using a evenly spaced area of Raised Disks 11, which contain Magnetic Disks 13 and portion for lip Holders 12.

In a typical situation, a tool may be placed on the mat 10 in any position desired, whether it be upside down, sideways or straight. The tool or instrument will be held in place by the magnetic disks 13 under each raised disk 11.

Tool tips, such as drill bits, hex bits or screwdriver tips may be secured in place in the tip holders 12.

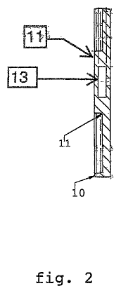

There is shown In FIG. 2, a side view of die mat 10 showing the raised disk 11 and the magnetic insert 13 within.

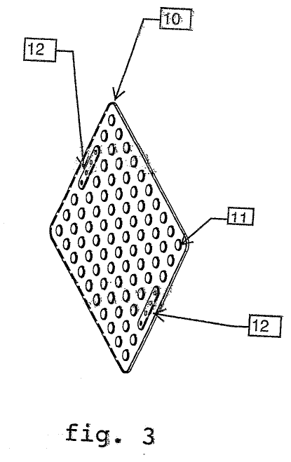

There is shown in FIG. 3 a perspective view of the mat 10, raised disks 11, and tip holders 12.

What is claimed is:

1. A flexible magnetic utility mat comprising:
a flexible material and a plurality of raised disks placed along the mat;
said raised disks are dispersed on one side of the said mat;
each said raised disk possessing a magnetic disk within said raised disk;
said raised disk portions adapted for holding tools and parts;
said mat possessing a non-raised side;
said non-raised side adapted for adhering to metallic work space.
